(19) United States
(12) Patent Application Publication
(10) Pub. No.: US 2008/0121485 A1
(43) Pub. Date: May 29, 2008

(54) Torque transfer device

(75) Inventors: Mario Degler, Baden-Baden (DE); Bruno Mueller, Sasbach (DE)

Correspondence Address: Robert P. Simpson;Simpson & Simpson, PLLC, 5555 Main Street, Williamsville, NY, 14221-5406, US

(73) Assignee: LuK Lamellen und Kupplungsbau Beteiligungs KG, Buehl (DE)

(21) Appl. No.: 11/986,915

(22) Filed: Nov. 27, 2007

(30) Foreign Application Priority Data
Nov. 29, 2006 (DE) 10 2006 056 297.6

(51) Int. Cl. F16H 45/02

(52) U.S. Cl. 192/3.29

(57) ABSTRACT

A torque transfer device for transferring torque between a drive unit and a shaft that is rotatable around an axis of rotation, in particular a transmission input shaft, having a hydrodynamic torque converter, which includes a converter cover that is connectable to the drive unit, which converter cover may be coupled to a turbine wheel to transfer torque, which turbine wheel may be bridged by a torque converter lockup clutch, which includes a piston movable to a limited extent in the axial direction and is pressurizable by a hydraulic medium in a pressure chamber that extends in the axial direction between the piston and a pressure chamber limiting part. The pressure chamber limiting part includes a pressure equalizing device that enables an equalization of pressure between the pressure chamber and an intermediate space which extends partially in the axial direction between the converter cover and the pressure chamber limiting part.

### CROSS REFERENCE TO RELATED APPLICATIONS

This patent claims priority of German Patent Application No. 10 2006 056 297.6, filed Nov. 29, 2006, which application is incorporated herein by reference.

### FIELD OF THE INVENTION

The invention relates to a torque transfer device for a motor vehicle.

### SUMMARY OF THE INVENTION

The invention relates to a torque transfer device, in particular in the power train of a motor vehicle, for transferring torque between a drive unit and a shaft that is rotatable around an axis of rotation, in particular a transmission input shaft, having a hydrodynamic torque converter, which includes a converter cover that is connectable to or connected to the drive unit, which converter cover may be coupled via an impeller to a turbine wheel to transfer torque, which turbine wheel is bridgeable to transfer torque by a torque converter lockup clutch, which includes a piston that is movable to a limited extent in the axial direction and is pressurizable by a hydraulic medium in a pressure chamber that extends in the axial direction between the piston and a pressure chamber limiting part.

The object of the invention is to create a torque transfer device which is simply constructed and is capable of being manufactured economically.

The problem is solved with a torque transfer device, in particular in the power train of a motor vehicle, for transferring torque between a drive unit and a shaft that is rotatable around an axis of rotation, in particular a transmission input shaft, having a hydrodynamic torque converter which includes a converter cover that is connectable to or connected to the drive unit, which cover is couplable via an impeller to a turbine wheel to transfer torque, which turbine wheel is bridgeable to transfer torque by a torque converter lockup clutch, which includes a piston that is movable to a limited extent in the axial direction and is pressurizable by a hydraulic medium that is situated in a pressure chamber, where the pressure chamber extends in the axial direction between the piston and a pressure chamber limiting part, in that the pressure chamber limiting part is equipped with a pressure equalizing device that permits pressure equalization between the pressure chamber and an intermediate space which extends partially in the axial direction between the converter cover and the pressure chamber limiting part. The pressure equalizing device makes it possible for a compressible medium contained in the pressure chamber and/or the intermediate space, such as ambient air, to escape when the pressure chamber is filled with a viscous medium, in particular a hydraulic medium. That makes it possible to evacuate the air from the pressure chamber and/or the intermediate space in a simple manner.

A preferred exemplary embodiment of the torque transfer device is characterized in that the pressure equalizing device includes at least one check valve that blocks in the direction of the converter cover. On the one hand that prevents hydraulic medium from getting into the intermediate space, in particular from a cavity in the transmission input shaft, when pressure is applied to the piston. On the other hand, the check valve enables air to be evacuated from the intermediate space and/or the pressure chamber.

Another preferred exemplary embodiment of the torque transfer device is characterized in that the pressure equalizing device includes a through hole, in particular a central through hole, in the pressure chamber limiting part. Alternatively or in addition, the pressure equalizing device can include a plurality of through holes that are situated at different effective radii and angle divisions.

Another preferred exemplary embodiment of the torque transfer device is characterized in that the pressure equalizing device is integrated directly into the pressure chamber limiting part. That has the advantage that additional elements may possibly be dispensed with.

Another preferred exemplary embodiment of the torque transfer device is characterized in that the pressure equalizing device includes at least one closing element which closes the in particular central through hole in the pressure chamber limiting part when the pressure in the pressure chamber is greater than the pressure in the intermediate space, and which opens when the pressure in the pressure chamber is lower than the pressure in the intermediate space. The pressure equalizing device is preferably effective at small pressure differences. The closing device can be designed as a sphere, taper or cone, or as a surface with centering.

Another preferred exemplary embodiment of the torque transfer device is characterized in that the closing element is in contact with a sealing surface, and/or is movable in the axial direction, in particular against the pre-stressing force of a valve spring. When the closing element moves in the axial direction, then at least part of the cross section of the through hole is freed in order to enable medium to pass through.

Another preferred exemplary embodiment of the torque transfer device is characterized in that the closing element is pre-stressed into a defined starting position. Preferably the closing element is pre-stressed into its closing position, in which the closing element closes the through hole.

Another preferred exemplary embodiment of the torque transfer device is characterized in that the closing element is movable in the axial direction against the pre-stressing force of a valve spring. A defined primary pressure for opening or closing the closing element can be set through the pre-stressing force of the valve spring.

Another preferred exemplary embodiment of the torque transfer device is characterized in that the closing element is in contact with a holder body that is attached to the pressure chamber limiting part and has at least one through hole. The through hole permits the passage of medium.

Another preferred exemplary embodiment of the torque transfer device is characterized in that the holder body is made as a sheet metal part which is crimped, welded, soldered, rolled, wedged or riveted to the pressure chamber limiting part. The sheet metal part is preferably elastically springy.

Another preferred exemplary embodiment of the torque transfer device is characterized in that the pressure chamber limiting part is part of an output part of a torsional vibration damping device, which is connected ahead of the torque converter lockup clutch. Preferably a plate carrier of a multi-plate clutch is attached to the output part.

Another preferred exemplary embodiment of the torque transfer device is characterized in that the torsional vibration damping device includes a first torsional vibration damper which acts between the converter cover and the output part, and a second torsional vibration damper which acts between the turbine wheel and the shaft. The torsional vibration damping device is preferably constructed as a double damper.

### BRIEF DESCRIPTION OF THE DRAWINGS

Additional advantages, characteristics and details of the invention are evident from the following description, in which various embodiments are described in detail with reference to the drawing. The figures show the following:

FIG. 1 is a half-sectional view of a torque transfer device according to a first exemplary embodiment; and,

FIGS. 2 to 5 each showing an enlarged detail from FIG. 1 according to additional exemplary embodiments.

### DETAILED DESCRIPTION OF THE INVENTION

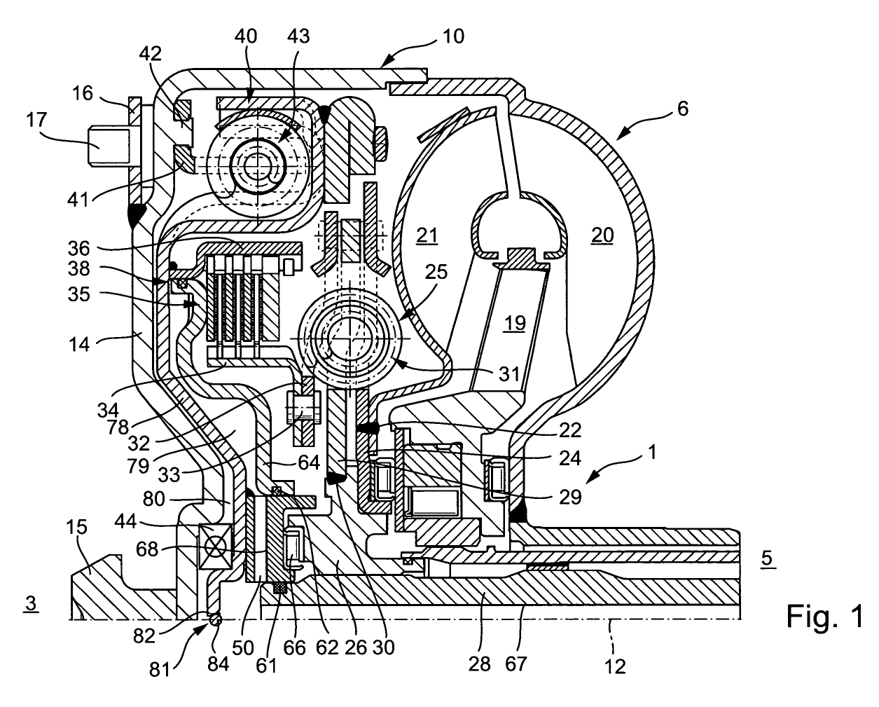

Part of power train 1 of a motor vehicle is depicted in FIG. 1. Between drive unit 3, in particular a combustion engine, which is only indicated by a reference label and from which a crankshaft emerges, and transmission 5, which is also only indicated by a reference label, hydrodynamic torque converter 6 is situated. The crankshaft of combustion engine 3 is connected to housing 10 of torque converter 6 in a rotationally fixed connection, for example through a sheet metal drive plate, also known as a flex plate. Housing 10 of torque converter 6 is rotatable around axis of rotation 12, and is equipped with housing wall 14 close to the drive, which is also called the converter cover.

Attached to converter cover 14 is central pilot bearing pin 15, whose function is to pre-center hydrodynamic torque converter 6 during installation in a central recess in the crankshaft. Welded radially on the outside of converter cover 14 is sheet metal linking plate 16, from which threaded bolts 17 protrude, with which converter cover 14 is attached to the sheet metal drive plate.

Hydrodynamic torque converter 6 includes guide wheel 19, impeller 20 and turbine wheel 21. Turbine wheel 21 is firmly connected to side plate 24 by welded joint 22. Side plate 24 represents the input part of torsional vibration damper 25, which is situated in the axial direction between converter cover 14 and turbine wheel 21. Torsional vibration damper 25 includes damper hub 26, on which side plate 24 and turbine wheel 21 attached thereto are rotatably mounted radially on the outside.

Damper hub 26 is connected radially on the inside to transmission input shaft 28 in a rotationally fixed connection. The output part of torsional vibration damper 25 is formed of damper flange 29, which is firmly connected to damper hub 26 by welded seam 30. Damper flange 29 is coupled with side plate 24 and another side plate 32, with spring elements 31 interposed. Side plate 32, which represents another input part of torsional vibration damper 25, is firmly connected to inside plate carrier 34 of torque converter lockup clutch 35 in lamellar construction by rivet fastening elements 33.

Torque converter lockup clutch 35 also includes outside plate carrier 36, which is attached to output part 38 of another torsional vibration damper 40. Torsional vibration damper 40 includes input part 41, which is attached to converter cover 14 by rivet fastening elements 42. Rivet fastening elements 42 are formed by rivet bosses which protrude from converter cover 14. Input part 41 of torsional vibration damper 40 is coupled with output part 38 through spring elements 43. Situated between output part 38 of torsional vibration damper 40 and converter cover 14 is roller bearing 44, in particular a ball bearing. Output part 38 of torsional vibration damper 40 is rotatably mounted on converter cover 14 through roller bearing 44. Torsional vibration damper 40 and torsional vibration damper 25 form a double damper.

Roller bearing 44 is supported on output part 38. Output part 38 of torsional vibration damper 40 is welded firmly to hub part 50. A stepped end of transmission input shaft 28 is rotatably situated in hub part 50 and has a sealing effect. To improve the sealing effect, sealing ring 61 is partially received in an annular groove, which is formed in the stepped end of the transmission input shaft. Hub part 50 rests against sealing ring 61. Another sealing ring 62 is partially received in annular groove which is formed on piston 64 of torque converter lockup clutch 35. Piston 64 is mounted on hub part 50 so that it is axially movable and possibly rotatable, and provides a sealing effect.

Bearing device 66 is positioned in the axial direction between hub part 50 and damper hub 26. Bearing device 66 is preferably an axial bearing, which serves to support axial forces. Alternatively or additionally, however, it can also be a radial bearing. Bearing 66 is designed for example as a journal bearing or as a roller bearing.

Transmission input shaft 28 is provided internally with a central cavity for feeding in or removing hydraulic medium. Cavity 67 is connected to pressure chamber 79 through flow channel 68, which extends through hub part 50 in the radial direction. Pressure chamber 79 is bounded by output part 38 of torsional vibration damper 40 and piston 64 of torque converter lockup clutch 35.

Output part 38 of torsional vibration damper 40 includes pressure chamber limiting section 78, which is also referred to as a pressure chamber limiting part. Pressure chamber 79 is formed in the axial direction between pressure chamber limiting part 78 and piston 64 of torque converter lockup clutch 35. Pressure chamber 79 is connected with cavity 67 in the interior of transmission input shaft 28 through flow channel 68. Pressure chamber 79 is filled with hydraulic medium through cavity 67 and flow channel 68. Piston 64 of torque converter lockup clutch 35 is actuated by the hydraulic medium, or the pressure that the hydraulic medium exerts on piston 64.

Intermediate space 80 is formed in the axial direction between converter cover 14 and pressure chamber limiting part 78. Intermediate space 80 is filled, for example, with ambient air. When piston 64 of torque converter lockup clutch 35 is actuated, ambient air contained in the interior of housing 10 is displaced. According to an essential aspect of the present invention, the ambient air displaced from the interior of housing 10 can escape from intermediate space 80 through a pressure equalizing device. Pressure equalizing device 81 includes a central through-hole 82, which is left free in pressure limiting part 78 or output part 38 of torsional vibration damper 40 and is closable by closing element 84. Closing element 84 is preferably in the form of a sphere. Central through-hole 82 creates a connection between intermediate space 80 and cavity 67 in the interior of transmission input shaft 28.

FIGS. 2 through 5 each depict a detail from FIG. 1 according to different exemplary embodiments. The same reference labels are used to designate the same parts. To avoid repetitions, we refer to the preceding description of FIG. 1. In the following description we primarily describe the differences between the pressure equalizing devices.

The exemplary embodiment depicted in FIG. 2 includes pressure equalizing device 91, which is executed as a check valve. Check valve 91 includes central through-hole 92, which is left free in pot-like area 93 of pressure chamber limiting part 78. Central through-hole 92 is closable by closing element 94, which is executed as a sphere. Closing element 94 is held in contact with central through-hole 92 by holder body 95. Holder body 95 is executed as a sheet metal part, and includes central pot-like area 96 that has central through-hole 97. Holder body 95 is attached radially on the outside in annular groove 98, which is recessed in pressure chamber limiting part 78. Closing element 94 is fixed between two through-holes 92 and 97 in such a way that when a pressure difference occurs it enables an equalization of pressure with cavity 67 in transmission input shaft 28. That is equivalent to a pressure equalization between the intermediate space (18 in FIG. 1) and the pressure chamber (79 in FIG. 1).

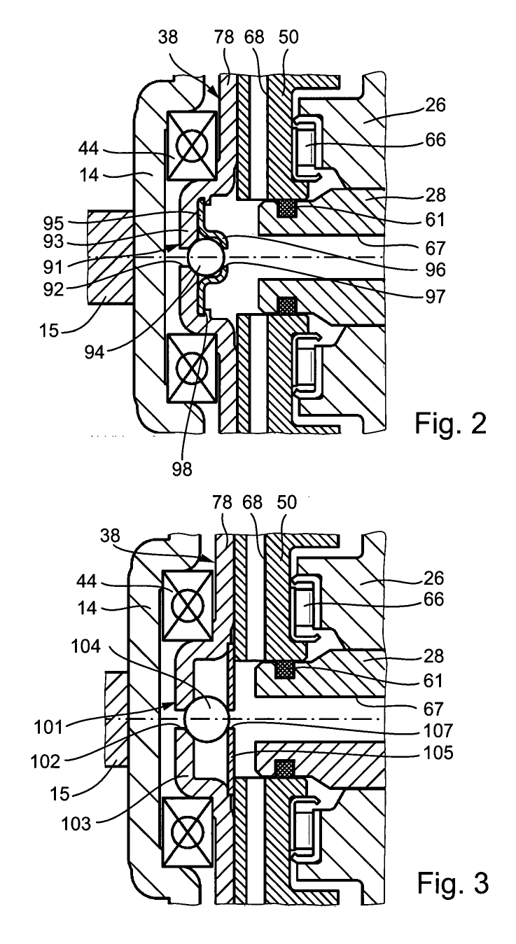

FIG. 3 depicts pressure equalization device 101 which is executed as a check valve. Check valve 101 includes central through-hole 102, which is left free in pot-like area 103 of pressure chamber limiting part 78. Central through-hole 102 is closed by closing element 104, which is fixed between central through hole 102 and another central through-hole 107 of holder body 105. Holder body 105 has essentially the form of a circular washer, which is fixed radially between pressure chamber limiting part 78 and hub part 50. Holder body 105 is elastically springy, so that closing element 104, which is executed as a sphere, can move away from central through-hole 12 in the axial direction. Holder body 105 with central through-hole 107 is at the same time designed so that a pressure equalization takes place through two through-holes 102 and 107 when closing element 104 lifts off of central through-hole 102.

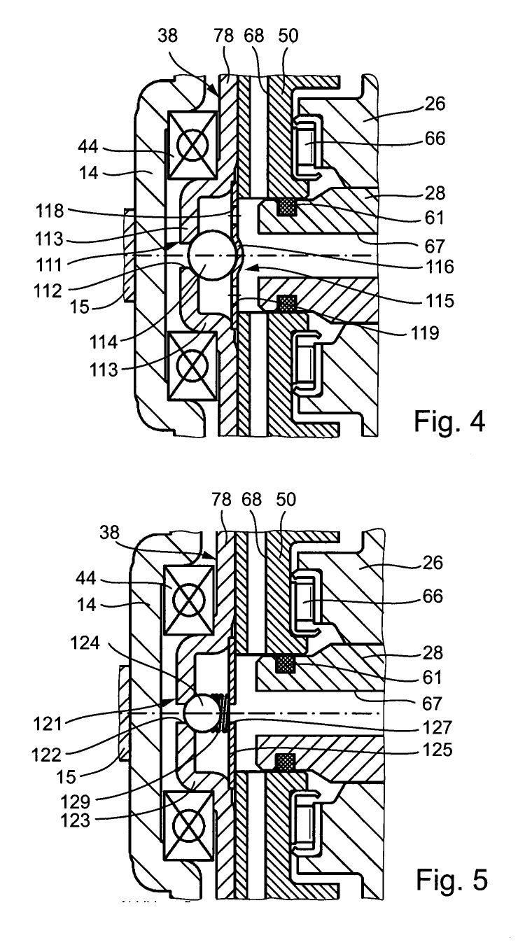

FIG. 4 depicts pressure equalization device 111 which is executed as a check valve. Check valve 111 includes central through-hole 112, which is left free in pot-like area 113 of pressure chamber limiting part 78. Central through-hole 112 is closable by closing element 114, which is executed as a sphere. Closing element 114 is fixed between central through-hole 112 and spherical-segment-shaped area 116 of holder body 115. Radially outside of spherical-segment-shaped area 116, holder body 115 has a plurality of through-holes 118, 119. Through-holes 118, 119 enable the medium to pass through when closing element 114 lifts off from central through-hole 112. Holder body 115 is executed as a sheet metal part, elastically springy.

FIG. 5 depicts pressure equalization device 121 which is executed as a check valve. Check valve 121 includes central through-hole 122, which is left free in pot-like area 123 of pressure chamber limiting part 78. Central through-hole 122 is closable by closing element 124, which is executed as a sphere. Helical compression spring 129 is fixed between closing element 124 and holder body 125, which has central through-hole 127. Closing element 124 is kept in contact with central through-hole 122 by the pre-stressing force of helical compression spring 129.

The pressure equalizing device depicted in various exemplary embodiments in FIGS. 1 through 5 enables balancing of gaseous and fluid media between delimited pressure chambers 79, 80. It serves to pass the medium through pressure equalizing device 81, 91, 101, 111, 121 when pressure differences are small, and to vent intermediate space 80 and/or pressure chamber 79 with surplus gas, so that the fluid medium occupies the space. The pressure equalizing device includes one or more sealing elements, which are axially movable in order to enable flow-through at times at a possible sealing surface.

The axially movable and moving sealing element or closing element can be executed for example as a sphere, taper, cone, or as a surface with centering. The closing element opens and closes between two pressure chambers, which are designated as pressure chamber 79 and as intermediate space 80. The embodiment can be incorporated directly into pressure chamber limiting part 78 without additional elements. The sealing element can be fixed in its starting position, defined or undefined, by additional elements, such as any sort of springs for example. That enables the closing element to be brought to a desired starting position, which is also designated as the zero position. A desired primary pressure for opening or closing the flow passage can also be set thereby.

### REFERENCE NUMBERS

1 power train
3 drive unit
5 transmission
6 hydrodynamic torque converter
10 housing
12 axis of rotation
14 housing wall
15 pilot bearing pin
16 sheet metal linking plate
17 threaded bolt
19 guide wheel
20 impeller
21 turbine wheel
22 welded connection
24 side plate
25 torsional vibration damper
26 damper hub
28 transmission input shaft
29 damper flange
30 welded seam
31 spring element
32 side plate
33 rivet fastening elements
34 inner plate carrier
35 torque converter lockup clutch
36 outer plate carrier
38 output part
40 torsional vibration damper
41 input part
42 rivet fastening element
43 spring elements
44 roller bearing
50 hub part
61 sealing ring
62 sealing ring
64 piston
66 bearing device
67 cavity
68 flow channel
78 pressure chamber limiting part
79 pressure chamber
80 intermediate space
81 pressure equalizing device
82 central through hole
84 closing element
91 pressure equalizing device
92 central through hole
93 pot-like area
94 closing element
95 holder body
96 pot-like area
97 through hole
98 annular groove
101 pressure equalizing device
102 central through hole
103 pot-like area
104 closing element
105 holder body
107 central through hole
111 pressure equalizing device
112 central through hole
113 pot-like area
114 closing element
115 holder body
116 area
118 through hole
119 through hole
121 pressure equalizing device
122 central through hole
123 pot-like area
124 closing element
125 holder body
127 central through hole
129 helical compression spring

What is claimed is:

1. A torque transfer device, in particular in the power train of a motor vehicle, for transferring torque between a drive unit (3) and a shaft (28) that is rotatable around an axis of rotation, in particular a transmission input shaft, having a hydrodynamic torque converter (6), which includes a converter cover (14) that is connectable to or connected to the drive unit (3), which converter cover may be coupled via an impeller (20) to a turbine wheel (21) to transfer torque, which turbine wheel may be bridged to transfer torque by a torque converter lockup clutch (35), which includes a piston (64) that is movable to a limited extent in an axial direction and is pressurizable by a hydraulic medium in a pressure chamber (79) that extends in the axial direction between the piston (64) and a pressure chamber limiting part (78), wherein the pressure chamber limiting part (78) is equipped with a pressure equalizing device (81; 91; 101; 111; 121) that enables a pressure equalization between the pressure chamber (79) and an intermediate space (80) that extends partially in the axial direction between the converter cover (14) and the pressure chamber limiting part (78).

2. The torque transfer device recited in claim 1, wherein the pressure equalizing device (81; 91; 101; 111; 121) includes at least one check valve that blocks in the direction of the converter cover (14).

3. The torque transfer device recited in claim 1, wherein the pressure equalizing device (81; 91; 101; 111; 121) includes a through hole, in particular a central through hole (82; 92; 102; 112; 122) in the pressure chamber limiting part (78).

4. The torque transfer device recited in claim 1, wherein the pressure equalizing device (81; 91; 101; 111; 121) is integrated directly into the pressure chamber limiting part (78).

5. The torque transfer device recited in claim 3, wherein the pressure equalizing device (81; 91; 101; 111; 121) includes at least one closing element (84; 94; 014; 114; 124) which closes, in particular, the central through hole (82; 92; 102; 112; 122) in the pressure chamber limiting part (78) when the pressure in the pressure chamber (79) is greater than the pressure in the intermediate space (80), and which opens when the pressure in the pressure chamber (79) is lower than the pressure in the intermediate space (80).

6. The torque transfer device recited in claim 5, wherein the closing element (84; 94; 014; 114; 124) is in contact with a sealing surface and/or is movable in the axial direction, in particular against the pre-stressing force of a valve spring (129).

7. The torque transfer device recited in claim 5, wherein the closing element (84; 94; 014; 114; 124) is pre-stressed into a defined starting position.

8. The torque transfer device recited in claim 5, wherein the closing element (124) is movable in the axial direction against the pre-stressing force of a valve spring (129).

9. The torque transfer device recited in claim 5, wherein the closing element (94; 104; 114) is in contact with a holder body (95; 105; 115) that is fastened to the pressure chamber limiting part (78) and has at least one through-hole (97; 107; 118, 119).

10. The torque transfer device recited in claim 9, wherein the holder body (95; 105; 115; 125) is designed as a sheet metal part which is crimped, welded, soldered, rolled, wedged or riveted to the pressure chamber limiting part (78).

11. The torque transfer device recited in claim 1, wherein the pressure chamber limiting part (78) is part of an output part (38) of a torsional vibration damping device which is connected ahead of the torque converter lockup clutch (35).

12. The torque transfer device recited in claim 11, wherein the torsional vibration damping device includes a first torsional vibration damper (40) which acts between the converter cover (14) and the output part (38), and a second torsional vibration damper (25) which acts between the turbine wheel (21) and the shaft (28).
